(19) United States
(12) Patent Application Publication
(10) Pub. No.: US 2009/0251836 A1
(43) Pub. Date: Oct. 8, 2009

(54) CIRCUIT BREAKER METER

(76) Inventor: Hilmir Ingi Jonsson, Reykjanesbaer (IS)

Correspondence Address: Muncy, Geissler, Olds & Lowe, PLLC, P.O. BOX 1364, FAIRFAX, VA, 22038-1364, US

(21) Appl. No.: 12/161,287

(22) PCT Filed: Jan. 18, 2007
(86) PCT No.: PCT/IS07/00002

§ 371 Date: Nov. 6, 2008

(30) Foreign Application Priority Data
Jan. 18, 2006 (IS) 8240

(51) Int. Cl. H02H 3/08

(52) U.S. Cl. 361/93.1

(57) ABSTRACT

An electricity metering arrangement comprises a circuit breaker with an installed light indicating electricity meter displayed on the front of the unit. The electricity meter comprises a light indicating unit which may be a LED light or LCD display. The circuit breaker based on the invention is combined with a circuit breaker housing (1), a circuit breaker (2) and a built-in light indicating electricity meter (3). It is controlled with a switch (4) and has a fastening unit (5) on the back of the housing. Connections are made to the circuit breaker with screws on top (6) and under (7) the housing. Measurements are displayed on front of the circuit breaker by a light indicator with a scale (8) indicating the electricity load status.

### FIELD OF INVENTION

The present invention relates generally to the field of electrical safety and circuitry.

### DESCRIPTION

The invention regards electricity metering circuit breaker devise. It is a safety devise. The circuit breaker based on the invention is combined with a circuit breaker housing which holds the circuit breaker and the characterized light indicating electricity meter. It is controlled with a switch and has a fastening unit on the back of the circuit breakers housing. Wires are fastened and connected to the circuit breaker and the electricity meter with screws or wire plug-in connections on top and bottom of the circuit breaker housing. The circuit breaker meter based on the invention is used as a switching devise capable of malting, carrying and breaking currents under normal circuit conditions and making and breaking currents under specified abnormal conditions such as short circuit and/or electrical overload. Also while switched on the circuit breaker meter will show the current electrical load in use. Measurements are displayed on the front of the housing by a light indicator or a LCD monitor showing the electricity load flowing through the circuit breaker. The circuit breaker meter will also notify dangerous overload situations before breaking the circuit with a warning signal sound. The circuit breaker based on the invention does not in any way restrict the given look of the circuit breaker shown in the drawing section and can be manufactured in many various forms and sizes.

### BACKGROUND OF THE INVENTION

Circuit breakers are important safety mechanisms. As the name implies a circuit breaker stops the flow of power whenever there is too much electricity moving through the wiring. While it may seem inconvenient at times for the power to go out, this function of circuit breakers prevents electrical fires from breaking out. Ultimately, circuit breakers usually come into play when there is damage to a home appliance or too many home appliances connected, when the walls have been ill-wired or some other accident creates a dangerous situation among the circuitry. Conventional circuit breakers make use of levers and electromagnets to break or open, the circuit. Basically, when an unsafe surge of electricity occurs, the electromagnet in the breaker becomes more magnetized which then pulls a switch that opens the circuit. Other circuit breakers use a bimetallic strip that is attached to a switch. When the overload occurs, the strip bends thereby opening the switch. Electricity measuring units such as kwh and/or KVarh meters show by numbers the electricity used in a single circuit base or in whole by a circuit base series but they cannot show the electrical load status of any circuit breaker, whether the load is low or high or even too high. Also these meters are plugged with removable fuses typically rated at 60, 80 or 100 amps so these meters can not be used as a circuit breaker in a typical circuit breaker base because of the size of the fuse. Conventional circuit breakers can prevent overloading wires, machinery and appliances by limiting the circuit in amps, for example a 10 amp circuit breaker will ultimately break the circuit if exceeded that amount of amps. Separate watt meters, amp meters and volt meters or AVO meters have been used to measure the electricity load in circuit breakers. These meters show by either digital numbers on a monitor or by lights on a light measuring scale the desired results.

### Technical Problem

In every facility, domestic or industrial, there is electricity and that electricity is divided into circuit breaker bases to ensure that for example the lighting and the power devises used do not exceed the wiring or the electrical consumption limits of the devises. When a circuit breaker base is fully loaded the wiring will heat up until the circuit breaks. If the circuit does not break immediately the heated wiring could melt the isolation of the wiring causing extreme fire hazard. The hazard will not be visible in any way until the circuit breaks eventually or a fire has emerged. When operating professional equipment which uses a large amount of electricity that is protected by a circuit breaker it is very difficult to monitor the electricity load used by the equipment to ensure safety from overload. The state of the circuit breaker is not visible without making measurements with a separate measuring unit. Separate watt meters, amp meters and volt meters or AVO meters have been used to measure the electricity load in circuit breakers. To use these meters you would have to have some knowledge of the meter to get the right results and understand them or get a professional to make the measurements for you. In both cases it will cost you time and money to get the results you are looking for.

### Technical Solution

By combining a circuit breaker and light indicating electricity meter creating a new devise. By adding the characterized light indicating electricity meter to the circuit breaker unit creates an easy, risk-free and visible way to check the electrical status and prevent overload by monitoring the amount of electricity added and used by the circuit breaker, also preventing the wires to overheat which causes damage to the wiring isolation with time which could then result in a destructive fire. The unit is or could be arranged to automatically send out a warning signal sound when overloaded, notifying the danger situation before the breaking of the circuit. The objective with the characterized light indicating electricity meter in a circuit breaker is to increase the electrical security level in domestic, industrial or commercial premises. It is another objective with the invention to simplify to the user if the electricity used in a circuit breaker is getting too high and to do so in a very visible and risk-free easy fashion. The objective is reached by placing the characterized light indicating electricity meter inside a circuit breaker with a light indicating scale in the front of the housing malting the load carried by the circuit breaker very visible to the consumer only by looking at the circuit breaker. Inside the circuit breaker the electricity meter is connected along with the circuit to a phase and then measuring the load carried by the phase and displaying the load through a series of lights indicating the load in-use. In a preferred version of the unit four green, two yellow and one red light will be lighted up to indicate the increasing load. The light indicators will light up as the load gets higher so you can monitor the load carried by every single circuit breaker, allowing you to monitor and control the load in use and therefore making your home or any other facility or buildings safer from electrical overloads and fire hazards. It is also another objective with the invention to make electrical fault tracking and maintenance for professionals easier as the light indicator will make it visible which circuit base is in risk and the warning signal sound will notify when the electricity load reaches a danger state before breaking the circuit.

### ADVANTAGEOUS EFFECTS OF HE INVENTION

The advantage effects of the circuit breaker meter based on the invention to a conventional circuit breaker are the visual electricity status monitoring ability, the warning signal sound for electrical overload ability and the electricity fault finding and maintenance ability.

### DESCRIPTION OF DRAWINGS

FIG. 1 shows the side of the inventions housing, 1 shows the housing of the circuit breaker, 2 shows the location of the circuit breaker, 3 shows the location of the characterized electricity meter, 4 shows the circuit breaker switch, 5 shows the fastening unit of the housing, 6 shows the connection of wires on top of the housing, 7 shows the connection of wires under the housing and 8 shows the light indicator or monitor and scale.

FIG. 2a shows the front of the invention with a square light indicating electricity meter scale embodied with LED lights or a LCD monitor. The scale indicates green lights as a normal status, yellow lights as a caution status and a red light as a danger status.

FIG. 2b shows the front of the invention with a circular LED light indicating electricity meter scale. The scale indicates green lights as a normal status, yellow lights as a caution status and a red light as a danger status.

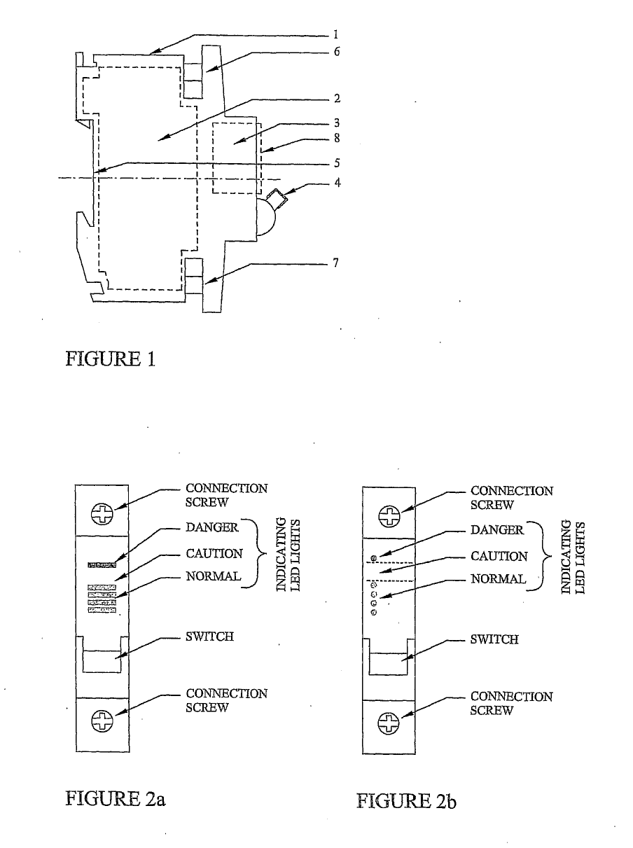

The circuit breaker based on the invention is combined with a circuit breaker housing (1), a circuit breaker (2) and a light indicating electricity meter (3). It is controlled with a switch (4) and has a fastening unit (5) on the back of the housing. Wires are fastened and connected to the circuit breaker with screws on top (6) and under (7) the housing.

Measurements are displayed on front of the housing by a light indicator with a scale or a monitor (8).

1-10. (canceled)

11. A circuit breaker device comprising,
a housing,
a fastening unit of the housing,
a wire connection portion, and
a circuit breaker switch,
the device further comprise an electricity meter having an acoustic and/or light pre-alarming means for alerting electrical overload.

12. The circuit breaker according to claim 11, in which the circuit breaker is arranged for use of a multi-phase supply.

13. The circuit breaker according to claim 11, in which the circuit breaking limit is of any available circuit breakers breaking limit.

14. The circuit breaker according to claim 11, in which the circuit breaker holds one or more characterized light indicating electricity meters.

15. The circuit breaker according to claim 11, in which the light indicator can be located in various places inside the circuit breakers housing.

16. The circuit breaker according to claim 14, in which the characterized light indicating electricity meter is placed inside the circuit breakers housing in whichever shape of the circuit breakers housing.

17. The circuit breaker according to claim 14, in which the characterized light indicating electricity meter holds and views one light or more.

18. The circuit breaker according to claim 17, in which the light indicator displays the lights in one color or more.

19. The circuit breaker according to claim 11, in which the connections to the unit are fastened with screws or wire plug-in connections.

20. An arrangement to measure electricity load in a circuit breaker using the characterized light indicating electricity meter located in the circuit breakers housing according to claim 11.
